(19) United States
(12) Patent Application Publication
(10) Pub. No.: US 2012/0022891 A1
(43) Pub. Date: Jan. 26, 2012

(54) Information Interface System

(76) Inventor: Guy P. Curtis, San Diego, CA (US)

(21) Appl. No.: 12/840,574

(22) Filed: Jul. 21, 2010

(51) Int. Cl. G06Q 50/00

(52) U.S. Cl. 705/3

(57) ABSTRACT

A system and method for controlling informational data of a patient includes an electronic database for archiving the informational data; a tag for identifying the patient; and an electronic device for linking the database and the ID tag with the linking device. In operation, the linking device uses identification data from the ID tag, and pre-programmed, security log-in data to establish access into the database. With this authorized access, selected data from the database can then be retrieved and used during the conduct of a patient visit protocol. After the patient visit has been completed, the database can be updated with any additional information obtained during the patient visit.

### FIELD OF THE INVENTION

The present invention pertains generally to electronic information systems. More particularly, the present invention pertains to electronic systems having archives of informational medical data that pertain to individual patients. The present invention is particularly, but not exclusively, useful for electronically presenting useful and relevant data from a patient's medical records for use by a medical attendant (physician) during a patient visit protocol.

### BACKGROUND OF THE INVENTION

During a patient visit protocol, the primary purpose of the attending physician, nurse or clinical staff attendant is essentially two-fold. They want to assess and evaluate the patient. In order to do this effectively, two pieces of information are essential. For one, the patient needs to be absolutely and positively identified. For another, the current (i.e. most recent) status of the patient must be known. From an informational perspective, the patient identification involves “fixed” data, and the patient status involves “modifiable” data. For a proper assessment and evaluation of a patient, both sets of data are equally important.

As a patient is being admitted to a medical facility (e.g. a hospital), the fixed data that will be used to identify the patient can be relatively easily obtained, in most cases. For purposes of the present invention, it is envisioned that this fixed data can be incorporated onto a Radio Frequency Identification (RFID) bracelet of a type developed and manufactured by eAcess LLC, a wholly owned subsidiary of Cubic Corporation. Preferably, the fixed data will include the patient's name, a medical record number, birth date/age, patient location, code status and family contact telephone number, allergies and primary physician. Once this fixed data has been “incorporated” onto the RFID bracelet, it is attached to the patient. The patient can then be subsequently identified, regardless of whether the patient is communicative.

As noted above, in addition to an accurate and positive identification of a patient, it is useful (i.e. essential) to have a current update of the patient's status. In some instances this may involve a substantial amount of data. If so, in order to be useful, the patient status data may need to be culled for relevant data. Further, due to the changing status of the patient, this patient data needs to be periodically updated and modified. In general, this modifiable patient status data will typically include the patient's most recent vital signs (weight/blood pressure/pulse/respiratory rate), most recent diagnosis, as well as current medications, labs and notes from other medical personnel. The system includes a feature that allows additions to be made to the medical record (notes, assessment, plans) and patient orders initiated. This data may also include a log of patients visited (daily patient list for follow-up and billing). This modifiable data can be electronically stored in an intermediate database that is separate from, but communicates with, the health system database. The import here is that all of the fixed and modifiable data needs to be electronically available for effective and efficient use during a patient visit protocol.

In light of the above, it is an object of the present invention to provide a system and method for controlling informational data of a patient that requires an accurate identification of the patient and the user (e.g. an attending physician) before access to the medical data of the patient that is archived in an electronic database is authorized. Another object of the present invention is to provide a system and method for controlling the informational data of a patient that is useful and relevant for use by medical staff during a patient visit protocol. Another object of the present invention is to provide a system and method for controlling informational data of a patient, wherein the data that is archived in an electronic database can be updated and modified for use at a subsequent patient visit protocol. Still another object of the present invention is to provide a system and method for controlling informational data of a patient that is easy to implement, is simple to use, and is comparatively cost effective.

### SUMMARY OF THE INVENTION

A system in accordance with the present invention includes an electronic database that is used to archive informational data. Specifically, for purposes of the present invention, this informational data is pertinent to individual patients. More specifically, data in the database pertains to medical/clinical information that is useful for planning a treatment regimen for a patient. Another operational component of the system is a Radio Frequency Identification (RFID) tag that can be affixed to the patient and used to positively identify the patient. The central component of the system, however, is a linking device (i.e. an active RFID handheld reader/transmitter) that can retrieve fixed data from the patient RFID tag, and also establish a two-way communication channel with the database. As intended for the present invention, the so-called “fixed” (i.e. identification) data from the RFID tag, and the so-called “modifiable” data (i.e. medical/clinical information) from the database are to be used by an attending medical person during a visit with a patient in a medical facility. For the present invention, this “fixed” data is typically obtained from the patient, incorporated into the RFID tag, and attached to the patient at the time he/she is first admitted to the particular medical facility (e.g. hospital). As a general matter, this “fixed” data includes the patient's name, a medical record number, his/her birth date/age, patient location, code status and family contact telephone number and name. It may also include the patient's allergies and an identification of the patient's primary physician. It is also intended for the present invention that the “fixed” and “modifiable” data in the database can be updated, and administrative tasks attended to, after the patient visit.

For the operation of the system of the present invention, a user (e.g. an attending physician or medical staff personnel) will pre-program the linking device with a user profile. Importantly, this user profile will identify the particular user, and it will also establish informational categories of interest to the user. For example, these categories may typically include patient vital signs, current diagnosis, current medications, notes from medical personnel and lab results. The user profile can also include references to administrative details of the patient's interests such as treatment orders, patient visit logs and billing information.

During a patient visit protocol, the user will normally begin the visit by activating the linking device to obtain the “fixed” data from the RFID tag. The “fixed” data, along with the user profile, is then transmitted from the linking device to the electronic database, to obtain access to the database. Further, once access to the database has been obtained, the user profile is used to retrieve selected information from the database. Specifically, the selected information is chosen based on its usefulness and relevance for the conduct of the patient visit protocol.

After a patient visit protocol has been completed, and based on information obtained during the patient visit, the user can then update “modifiable” data in the database and initiate administrative tasks, such as prescribing medications and preparing reports. At this time, the user can also reconfigure the user profile. Importantly, these tasks can be accomplished using the linking device as an interface with the electronic database.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is an interactive presentation of the operative components for the system and method of the present invention; and

FIG. 2 is a functional schematic diagram of the methodology employed by the system of the present invention.

### DESCRIPTION OF THE PREFERRED EMBODIMENTS

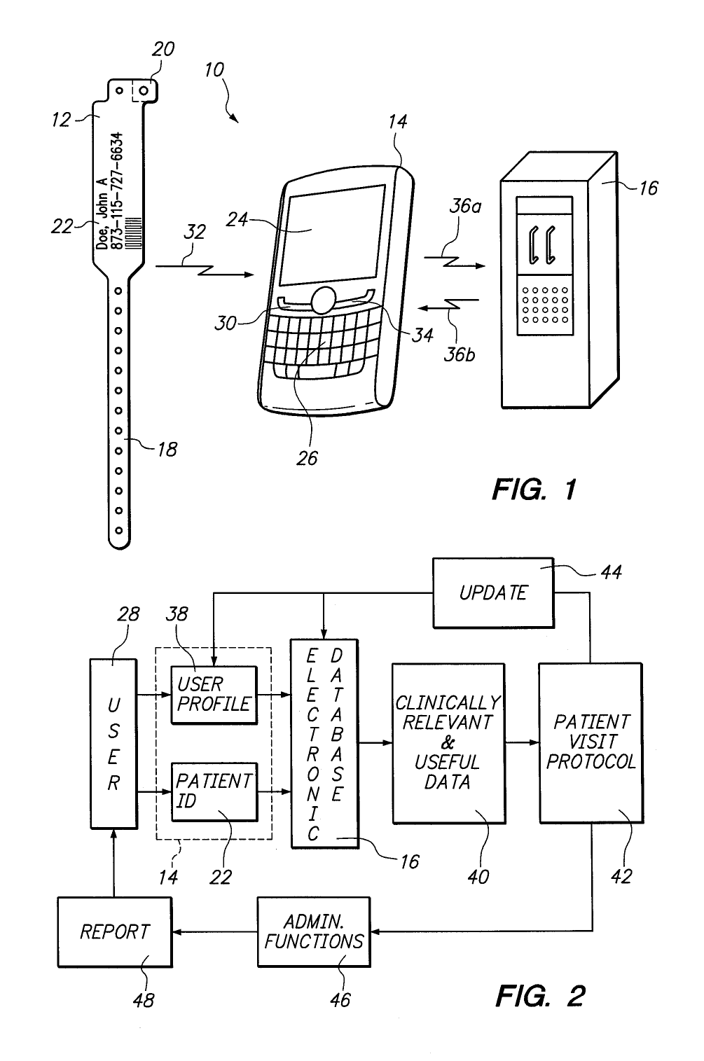

Referring initially to FIG. 1, the essential components of a system in accordance with the present invention are shown and are collectively designated 10. As shown, the system 10 includes an identification tag 12 that is attached to a patient (not shown) when the patient is initially admitted to a health care facility (e.g. a hospital). Also, the system 10 includes a linking device 14. More specifically, this linking device 14 is a handheld unit that can be carried by an attending physician, nurse or medical staff personnel whenever the patient is visited. Additionally, the system 10 will include an electronic database 16 that can be electronically accessed by the linking device 14 for two-way communication between the linking device 14 and the electronic database 16.

Structurally, the identification tag 12 is preferably a bracelet having a strap 18 that can be engaged with an attachment 20. With this engagement, the tag 12 can be attached to and held on the wrist of a patient. Importantly, the identification tag 12 will have an information field 22 that is located between the strap 18 and the attachment 20. This identification field 22 contains so-called “fixed” data that pertains directly to the identification of the patient. Electronically, the information field 22 is established using Radio Frequency Identification (RFID) technology. More specifically, the information field 22 is established using integrated proximity passive RFID. For purposes of the present invention, the “fixed” data in the information field 22 will include, patient name, medical record number, birth date/age, patient location (when admitted), code status and family contact telephone number and name, allergies and primary physician. Depending on data format and volume entries, the information field 22 may also include a listing of the top prescriptions for the patient, the patient's known conditions, and any other relevant data that may be of interest.

As shown in FIG. 1, the linking device 14 has a display screen 24 and a keypad 26. For the present invention, the linking device 14 is a mobile handheld unit that can be operated by a user 28 (see FIG. 2), who will normally be anyone authorized to conduct a visit protocol with the patient, such as an attending physician, nurse or medical/clinical staff personnel. The linking device 14 also has an ID button 30 which electronically connects it with the identification tag 12 for receipt of “fixed” information by the linking device 14 from the tag 12, as indicated by the arrow 32. Further, there is a data button 34 on the linking device 14 which electronically connects the linking device 14 in two-way wireless communication with the electronic database 16. In FIG. 1, this communication is indicated by the arrows 36a and 36b. For the system 10, both the communication between the identification tag 12 and the linking device 14, as well as the communication between the linking device 14 and the electronic database 16 are preferably encrypted.

An important feature of the linking device 14 is its user profile 38 (see FIG. 2). As intended for system 10, the purpose of this user profile 38 is essentially two-fold. For one, the user profile 38 provides a security log-in control for access to the electronic database 16. For another, the user profile 38 can tailor or customize the data that is to be retrieved from the database 16. In general, as will be appreciated by the skilled artisan, the electronic database 16 will contain all of the digital data that is pertinent to a patient, as well as similar data for every other patient at the facility. This data will, by its nature, necessarily be “modifiable”. More specifically, the “modifiable” data of the electronic database 16 will typically include a patient's most recent vital signs (weight/blood pressure/pulse/respiratory rate), their most recent diagnosis, current medications and labs, a log of patients visited (daily patient list for follow-up and billing) and any other information of interest.

With cross reference to both FIG. 1 and FIG. 2, it will be appreciated that an operation of the system 10 begins when a patient is admitted to a medical facility (e.g. a hospital). At the time of admission, or as soon thereafter as is realistically feasible, the “fixed” data is provided by the patient and is incorporated into the identification tag 12. The patient is then moved to his/her assigned location at the facility. At the same time (i.e. during admission), as much “modifiable” data as possible is input to the electronic database 16 either by the patient's primary care physician or by staff. The system 10 is now ready for operation.

During a patient visit in the facility, the user 28 will initially retrieve the “fixed” data from the identification tag 12 by holding the linking device 14 in the proximity of the tag 12 (e.g. within 10 cm), and pressing the ID button 30 on the linking device 14. Then, or earlier if possible, the user 28 establishes informational categories for the user profile 38 that will specify data to be retrieved from the electronic database 16. Recall, the user profile 38 is pre-programmed (using the keypad 26) with a user security log-in control that is necessary for accessing the database 16. In the event, the user 28 presses the data button 34 on the linking device 14, and both the “fixed” data from the identification tag 12 and the pre-programmed user profile 38 are transmitted to the electronic database 16 (arrow 36a). The consequence here is that selected information is retrieved from the database 16 and made available for viewing on the display screen 24 of linking device 14 (arrow 36b). As indicated in FIG. 2 this selected information will be clinically relevant and useful data (see block 40). And, importantly, it will be available for the conduct of a protocol during a visit by the user 28 with the patient. During this visit, the user 28 will typically obtain additional data (i.e. changed or more current data) that will be subsequently beneficial.

After a patient visit has ended and the patient visit protocol (see block 42) has been completed, the system 10 provides a capability for the user 28 to update and modify data (see block 44) in the electronic database, and in the user profile 38. Additionally, based on the patient visit and the additional data, administrative functions such as the writing of prescriptions and providing billing information can be accomplished (block 46). Any necessary report(s) 48 can also be prepared.

While the particular Information Interface System as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for controlling informational data of a patient which comprises:
an electronic database for archiving the informational data;
an identification tag attached to the patient, wherein the tag contains fixed data pertaining to the patient; and
an electronic linking device including a programmable user profile, wherein the device is connected in electronic communication with the database and with the tag, and wherein the device incorporates a selection feature for transmitting the fixed data and the user profile to the database for retrieval of selected data therefrom for use during a patient visit protocol.

2. A system as recited in claim 1 wherein the device further incorporates an update feature for modifying the database and the user profile with additional data obtained during the patient visit protocol.

3. A system as recited in claim 1 wherein the fixed data on the identification tag is chosen from a group comprising patient name, medical record number, birth date/age, patient location, code status and family contact telephone number and name, allergies and primary physician.

4. A system as recited in claim 3 wherein the user profile identifies the user and establishes informational categories for the retrieval of the selected data from the database.

5. A system as recited in claim 4 wherein the selected data is relevant to the patient and is useful to the user, and wherein the selected data is chosen from a group comprising most recent vital signs (weight/blood pressure/pulse/respiratory rate), most recent diagnosis, current medications and labs, and log of patients visited (daily patient list for follow-up and billing).

6. A system as recited in claim 1 wherein the tag is a Radio Frequency Identification (RFID) tag and the device includes an RFID reader.

7. A system as recited in claim 1 wherein the device further comprises a display screen for visually viewing the fixed data and the selected data during a patient visit protocol.

8. A method for controlling informational data of a patient which comprises the steps of:
providing an electronic linking device connected in electronic communication with an electronic database and with an identification tag, wherein the identification tag is attached to the patient, and wherein the electronic database archives informational data pertinent to the patient;
programming a user profile into the linking device, wherein the user profile establishes information categories pertinent to the patient;
inputting fixed data into the identification tag; and
activating a selection feature on the linking device to transmit the fixed data and the user profile, with an identification of the user, to the database for retrieval of selected data therefrom for use during a patient visit protocol.

9. A method as recited in claim 8 further comprising the step of periodically modifying the database and the user profile with additional data obtained during the patient visit protocol.

10. A method as recited in claim 9 wherein the fixed data on the identification tag is chosen from a group comprising patient name, medical record number, birth date/age, patient location, code status and family contact telephone number and name, allergies and primary physician.

11. A method as recited in claim 9 wherein the user profile establishes informational categories for the retrieval of the selected data from the database.

12. A method as recited in claim 11 wherein the selected data is relevant to the patient and is useful to the user, and wherein the selected data is chosen from a group comprising most recent vital signs (weight/blood pressure/pulse/respiratory rate), most recent diagnosis, current medications and labs, and log of patients visited (daily patient list for follow-up and billing).

13. A method as recited in claim 12 wherein the tag is a Radio Frequency Identification (RFID) tag and the device includes an RFID reader.

14. A method as recited in claim 9 further comprising the step of presenting the fixed data and the selected data on a display screen on the linking device for visual viewing during a patient visit protocol.

15. A method as recited in claim 9 further comprising the step of preparing a report of the patient visit protocol.

16. A method as recited in claim 9 further comprising the step of performing administrative functions in accordance with the additional information obtained during the patient visit protocol.

17. A system for controlling informational data of a patient which comprises:
an electronic database for archiving the informational data;
an identification tag attached to the patient, wherein the tag contains fixed data pertaining to the patient; and
an electronic linking device having a programmed user profile, wherein the device includes a selection feature for accessing the database in response to the fixed data and the user profile to retrieve selected data from the database for use during a patient visit protocol, and wherein the device includes an update feature to modify the database and the user profile based on additional data obtained during the patient visit protocol.

18. A system as recited in claim 17 wherein the fixed data on the identification tag is chosen from a group comprising patient name, medical record number, birth date/age, patient location, code status and family contact telephone number and name, allergies and primary physician, and wherein the user profile identifies the user and establishes informational categories for the retrieval of the selected data from the database.

19. A system as recited in claim 18 wherein the selected data is relevant to the patient and is useful to the user, and wherein the selected data is chosen from a group comprising most recent vital signs (weight/blood pressure/pulse/respiratory rate), most recent diagnosis, current medications and labs, and log of patients visited (daily patient list for follow-up and billing).

20. A system as recited in claim 19 wherein the tag is a Radio Frequency Identification (RFID) tag and the device includes an RFID reader, and wherein the device further comprises a display screen for visually viewing the fixed data and the selected data during a patient visit protocol.
